(19) United States
(12) Patent Application Publication
(10) Pub. No.: US 2022/0098098 A1
(43) Pub. Date: Mar. 31, 2022

(54) ECO-EFFICIENT METHOD FOR MANUFACTURING CONCRETE

(71) Applicant: ARIEL SCIENTIFIC INNOVATIONS LTD., Ariel (IL)

(72) Inventors: Haim COHEN, Beit Hashmonai (IL); Yaniv KNOP, Tel Aviv (IL); Yaakov ANKER, Salit (IL)

(21) Appl. No.: 17/426,303

(22) PCT Filed: Jan. 26, 2020
(86) PCT No.: PCT/IL2020/050097

§ 371 Date: Jul. 28, 2021

Related U.S. Application Data
(60) Provisional application No. 62/797,473, filed on Jan. 28, 2019.

(51) Int. Cl. C04B 7/30; C04B 18/04; B09B 3/25; C02F 11/145

(52) U.S. Cl. CPC C04B 7/30; C04B 18/0472; C04B 2111/00775; C02F 11/145; B09B 3/25

(57) ABSTRACT

The present invention describes a method for manufacturing of a composite fixated material comprising the steps of: (a) providing bottom oil shale ash obtained after burning oil shale, said bottom oil shale (BOSA) comprises pozzolanic particles having size of about 10 to 4000 μm and being capable of adsorbing trace elements at their surface; (b) providing acidic waste comprising said trace elements; and (c) adding the BOSA provided in step (a) to the acidic waste provided in step (b) in amount of about 0.1-0.4 weight parts of said BOSA per one weight part of said waste, and mixing said waste with said BOSA, thereby obtaining a neutralised (scrubbed) precipitate with the fixated trace elements, wherein said neutralised (scrubbed) precipitate with the fixated trace elements constitutes said composite fixated material.

### TECHNICAL FIELD

The present application relates to the field of disposal and treatment of hazardous industrial wastes, in particular, chemical wastes produced by harmful chemical industries and unsuitable for recycling due to their contamination. In addition, the present application relates to an eco-efficient method for manufacturing concrete.

### BACKGROUND

In the past, electric power in many countries over the world was produced by burning heavy fuel oil. This mode of power production significantly changed after the oil crisis in the 1970s, when many governments decided to diversify their fuel supplies, and since then, many new power-generating facilities have been fuelled by coal, oil shale and gas.

There are many countries and regions in the world, which have their power supply partially covered by oil shale-fired thermal power plants. Estonia, for example, has over 90% basic power supply covered by such plants based on firing oil shale that drives steam turbines and generates megawatts of electricity. Every year about 11 million tons of oil shale is fired in Estonia producing 45-47% ash content. China, Germany, Romania and Russia have also significant amount of electricity produced by burning their oil shale.

Thermal power plants, which use oil shale as a fuel, normally employ one of the two combustion methods: the traditional pulverised firing (PF) method, which is used in the older units of oil shale-fired power plants, for example in Estonia, and the more advanced fluidised bed combustion (FBC) operating, for example, in Holcim cement factory in Germany and in Rotem power plant in Israel.

Two types of oil shale ash (OSA) are produced during burning of oil shale: the main residue is bottom ash (BOSA), which constitutes about 90%, and the rest is fly shale ash (FOSA).

The most serious problem today is the OSA handling. In compliance with the recent EU directives, the oil shale power plants in Europe must be switched over to a technology which minimises high alkaline liquid waste (dry, semidry or dense slurry technology). Although, the oil shale ash from boilers is not toxic to nature as such, the main cause for environmental hazardousness of ash fields is the highly alkaline water used in transporting ash and the presence of trace elements including heavy metals. The handling and transport of such a waste are not simple issues. Due to the high costs of treatment methods for neutralisation and removal of contained toxic metal ions, these wastes are preferably transferred to central hazardous waste treatment facilities, for example, Ramat Hovav in Israel. Whatever technology is used then for OSA removal, ash fields come into contact with millions of cubic metres of rainwater a year which becomes polluted.

OSA contains overall about 40% of calcium, which makes them a good potential chemical scrubber for acidic wastes. The questions of how to neutralise free lime (CaO) in oil shale ash as one of the most hazardous components and to remove trace elements seems to be particularly important questions. The same is true regarding neutralisation of free calcite (CaCO₃), which appears to be predominant in many oil shales.

As free lime reacts to water (slaking), formed Ca(OH)₂ is to some extent water-soluble. The aqueous solution, depending on the amount of water it is in contact with, may be highly alkaline and in addition to that a lot of heat is discharged at slaking. That might not cause big problems at small ash concentrations, e.g. when using oil shale ash as mineral fertiliser. However, it might cause considerable problems at such big concentrations of oil shale ash we can see in ash fields. In oil shale power plant ash fields, where the stored ash contains big amounts of free lime or Ca(OH)₂, it brings about the pollution of rainwater on the ash fields with Ca(OH)₂ or other water-soluble ash components and such a rise of pH (higher than pH 10) so that letting such water into nature is not allowed because of its environmental hazardousness.

Regarding the neutralisation of calcite, buffer solution pH is aligned by comprising several species, so this is a good aspect preventing the solution being alkaline.

The acidic wastes of chemical industries, particularly phosphate industries, worldwide are neutralised at the production site by adding lime or CaCO₃ to the acidic liquid waste in large settling ponds. After the OSA ponds are filled up with calcium precipitates and dried, the neutralised wastes are covered with a thick soil layer (for improved safe storage). This is a cost-effective process using heavy machinery and consuming land area.

Nevertheless, the OSA produced in the power plants can be an excellent potential neutralisation reagent for the acidic wastes. Tiit Kaluvee et al, in “Utilization of granulated oil shale ashes for neutralizing of acidic soils”, Proceedings of the 3rd International Congress on Water, Waste and Energy Management, Rome, 18-20 Jul. 2016, Science KNOW Conference, 1-4, demonstrated that OSA formed at power and heat production plants in Estonia can be granulated and used in liming of acidic soils within modern agricultural technology.

Influence of liming acid soils with OSA has different effects on soils. On the one hand it eliminates acidity of the soil, but on the other hand, it can pollute the soil with heavy metals and radioactive elements, such as U, Pb, Nb, Sr, Th, As, Cd, Hg, Cr and Ga. Most heavy metals have negative ecological significance due to their toxic, carcinogenic, and accumulative behaviour in animals and human beings. The adsorption of toxic metal ions by low-cost adsorbents such as OSA is a versatile and widely used method and has been studied extensively in the last decade confirming that OSA is a good potential material for the treatment of wastewater.

OSA produced in many fired power stations has an important potential as a component in cement production and other construction processes. The produced OSA is currently used for manufacturing cement, for example by Kunda Nordic Cement in Estonia, by Holcim in Germany, and by Fushun cement factory in China. It has been demonstrated that the properties of OSA are comparable to Portland cement in concrete mixes of high strength. Husam Al-Hamaiedh et al, in “Using Oil Shale Ash in Concrete Binder”, Electronic Journal of Geotechnical Engineering 2010, Vol. 15, pp. 601-608, reported that replacement of mortar cement by OSA with ratios of 10, 20, and 30% by weight decreased the 28-day compressive strength of mortar cubes by 7.4, 11.7, and 23% respectively, and concluded that the higher is the level of cement replacement by OSA, the lower is the compressive strength, and the longer is the curing period, the higher is the increase in compressive strength. Therefore, the OSA can be utilised in the construction industry as a substitute to aggregates and cement in concrete production.

However, Husam Al-Hamaiedh et al (2010) also found that OSA can be used as cement replacement in ratios only up to 20% without causing significant effects on the studied properties of cement. The same finding has recently been reported by Shehdeh Ghanna in “The Effect of Partial Replacement of Cement by Virgin Oil Shale Powder and/or Oil Shale Ash 011 Properties of Cement Mortar (Comparative Study)”, Journal of Engineering and Applied Sciences 2017, 12(20), pp. 5281-5285.

In view of the above, it is clear that acidic wastes of the chemical industry containing trace elements have to be treated in order to neutralise the acid and to fixate the toxic constituents of the wastes. Furthermore, the fixated product has to be stored in a specially designed and monitored storage facility. There is a long-felt need to appreciably reduce the cost of such treatments and to eliminate the need for storage of the wastes. The present invention is directed at solving these problems by using the fixated product as a partial substitute to cement, aggregates and natural sand in industrial concrete mixtures. The concrete manufactured by the present inventors is therefore ‘green’, having the cement replacement ratios higher than 20%, which results in the improved performance, and can be used for infrastructure purposes with absolutely no risk to the surrounding environment.

### SUMMARY

The present application relates to a method for manufacturing of a composite fixated material comprising the steps of:
(a) Providing bottom oil shale ash obtained after burning oil shale, said bottom oil shale (BOSA) comprises pozzolanic particles having size of about 10 to 4000 μm and being capable of adsorbing trace elements at their surface;
(b) Providing acidic waste comprising said trace elements; and
(c) Adding the BOSA provided in Step (a) to the acidic waste provided in Step (b) in amount of about 0.1-0.4 weight parts of said BOSA per one weight part of said waste, and mixing said waste with said BOSA, thereby obtaining a neutralised (scrubbed) precipitate with the fixated trace elements, wherein said neutralised (scrubbed) precipitate with the fixated trace elements constitutes said composite fixated material.

In some embodiments, said obtained composite fixated material is a cement-like powder or a cement-like blendable paste. In other embodiments, the method of the present invention further comprise the step of transferring said obtained composite fixated material to a site of landfill and allowing it to harden, thereby obtaining a hardened concrete composition comprising the stabilised acidic waste fixated on the BOSA particles. In still other embodiments, the method of the present invention further comprises the step of hardening said concrete composition. In some embodiments, said hardened concrete composition contains about 50-500 kg of the BOSA particles per one cubic meter of the composition and exhibits after 24 hours an increase in a compression strength of about 100-120%, and after 28 days—an increase in a compression strength of about 70-90%.

In further embodiments, said acidic waste is in a form of sludge or filtration cake. In yet further embodiments, said acidic waste is received from sewage sludge, sludge from municipal sanitary wastewater treatment centres, waste and wastewater treatment plants, sludge of lake or river sediments, petroleum refinery sludge, effluent sludge from pharmaceutical production, pulp and paper industry wastes, printing wastes, acrylic latex wastes, sludge from metal surface processing, leather industry wastes, and chemical industry wastes. In some embodiments, said acidic waste further comprises inorganic or organic compounds. In a specific embodiment, said inorganic or organic compounds are organophosphates, halogenated organic compounds, organometallic compounds, herbicides and pesticides. In another specific embodiment, said trace elements are radioactive or hazardous metals. Non-limiting examples of said radioactive or hazardous metals are the metals selected from U, Pb, Nb, Sr, Th, Cs, Ce, As, Cd, Hg, Cr and Ga.

In some embodiments, the composite fixated material obtained in the method of the present invention is further added to concrete mixes as a partial substitute to natural sand, aggregates and cement, for manufacturing concrete.

Various embodiments may allow various benefits and may be used in conjunction with various applications. The details of one or more embodiments are set forth in the accompanying figures and the description below. Other features, objects and advantages of the described techniques will be apparent from the description and drawings and from the claims

### BRIEF DESCRIPTION OF DRAWINGS

Disclosed embodiments will be understood and appreciated more fully from the following detailed description taken in conjunction with the appended figures. The drawings included and described herein are schematic and are not limiting the scope of the disclosure. It is also noted that in the drawings, the size of some elements may be exaggerated and, therefore, not drawn to scale for illustrative purposes. The dimensions and the relative dimensions do not necessarily correspond to actual reductions to practice of the disclosure.

FIG. 1 illustrates the electrostatic interactions of the trace metal cations in the solution with the aluminate and silicate anionic groups at the surface of the BOSA particles.

FIG. 2 illustrates chemical bonding between the BOSA particles, as a Lewis base, and trace metal cations, as a Lewis acid.

FIG. 3 illustrates electrostatic interactions of fine precipitates of insoluble metal salts, such as e.g. strontium carbonate (SrCO₃), via the BOSA particles at pH higher than 10.5 (usually, in an alkaline solution, the metal cations are precipitating in a form of compounds of metal oxides or hydroxides).

### DETAILED DESCRIPTION

In the following description, various aspects of the present application will be described. For purposes of explanation, specific configurations and details are set forth in order to provide a thorough understanding of the present application. However, it will also be apparent to one skilled in the art that the present application may be practiced without the specific details presented herein. Furthermore, well-known features may be omitted or simplified in order not to obscure the present application.

The term “comprising”, used in the claims, is “open ended” and means the elements recited, or their equivalent in structure or function, plus any other element or elements which are not recited. It should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a material comprising x and z” should not be limited to materials consisting only of elements x and z. Also, the scope of the expression “a method comprising the steps x and z” should not be limited to methods consisting only of these steps.

Unless specifically stated, as used herein, the term “about” is understood as within a range of normal tolerance in the art, for example within two standard deviations of the mean. In one embodiment, the term “about” means within 10% of the reported numerical value of the number with which it is being used, preferably within 5% of the reported numerical value. For example, the term “about” can be immediately understood as within 10%, 9%, 8%, 7%, 6%, 5%, 4%, 3%, 2%, 1%, 0.5%, 0.1%, 0.05%, or 0.01% of the stated value. In other embodiments, the term “about” can mean a higher tolerance of variation depending on for instance the experimental technique used. Said variations of a specified value are understood by the skilled person and are within the context of the present invention. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges, for example from 1-3, from 2-4, and from 3-5, as well as 1, 2, 3, 4, 5, or 6, individually. This same principle applies to ranges reciting only one numerical value as a minimum or a maximum. Unless otherwise clear from context, all numerical values provided herein are modified by the term “about”. Other similar terms, such as “substantially”, “generally”, “up to” and the like are to be construed as modifying a term or value such that it is not an absolute. Such terms will be defined by the circumstances and the terms that they modify as those terms are understood by those of skilled in the art. This includes, at very least, the degree of expected experimental error, technical error and instrumental error for a given experiment, technique or an instrument used to measure a value.

As used herein, the term “and/or” includes any and all combinations of one or more of the associated listed items. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

In one aspect of the present invention, there is a method for manufacturing of a composite fixated material comprising the steps of:
(a) Providing bottom oil shale ash obtained after burning oil shale, said bottom oil shale (BOSA) comprises pozzolanic particles having size of about 10 to 4000 μm and capable of adsorbing trace elements at their surface;
(b) Providing acidic waste comprising the trace elements; and
(c) Adding the BOSA of Step (a) to the acidic waste of Step (b) in amount of about 0.1-0.4 weight parts of the BOSA per one weight part of the waste, and mixing said waste with said BOSA, thereby obtaining a neutralised (scrubbed) precipitate with the fixated trace elements.

The acidic wastes comprising the trace elements can be any acidic toxic chemical industrial wastes, for instance, the wastes of the phosphate industry containing, for example, a mixture of sulfuric and phosphoric acid or a mixture of hydrochloric and phosphoric acid. Both of them contain a lot of trace elements, such as iron, vanadium, uranium, cadmium, lead, niobium, strontium, thorium, arsenic and gallium. Most heavy metals have negative ecological impact due to their toxic, carcinogenic, and accumulative behaviour in animals and human beings. Upon mixing with the BOSA, these toxic metals, or more precisely their ions, are capable of being adsorbed and fixated at the surface of the BOSA particles. These particles comprise a large amount of burnt lime, which is calcium oxide, and even more calcite, which is calcium carbonate, therefore, they are capable of neutralising acids via the following chemical reaction:

CaO+2H⁺→Ca²⁺+H₂O

CaCO₃+2H⁺→Ca²⁺+CO₂+H₂O

As a result of the above reactions, the neutralised calcium precipitate, which is a scrubbed product, is obtained. The solid particles of the obtained calcium precipitate incorporate the trace elements fixated on their surface. The fixation process itself actually involves aluminates —O—Al—O⁻ and silicates —O—SiO₂⁻ anionic groups occurring at the surface of the oil shale ash particles and interacting strongly with the trace elements via electrostatic and chemical interactions. Since the surface of the obtained particles is large, their fixating capacity is also large.

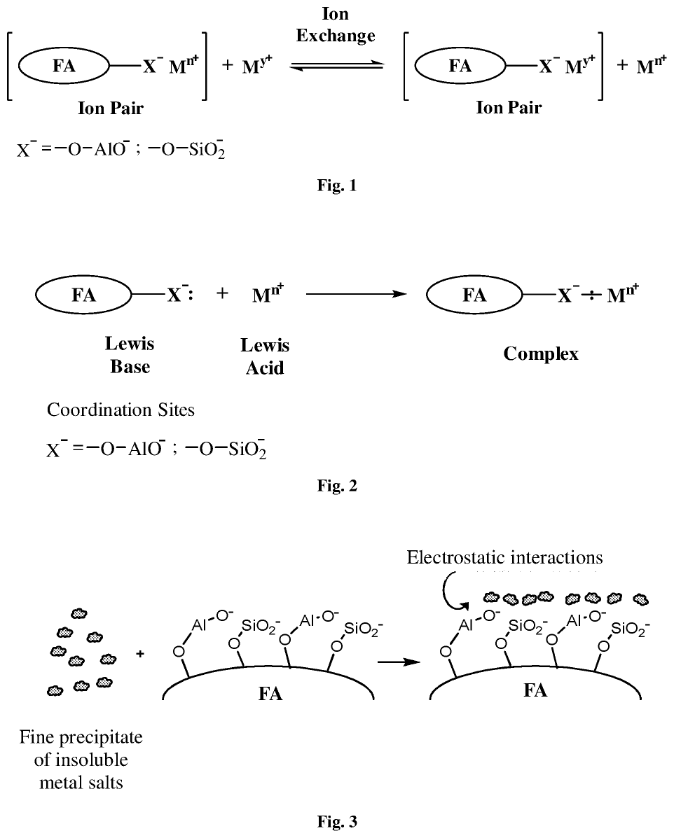

The BOSA particles can fixate the trace elements in three types of interaction as shown in FIGS. 1-3 below:
1) Reference is made to FIG. 1 showing electrostatic interactions of the trace metal cations in the solution with the aluminate and silicate anionic groups at the surface of the BOSA particles. This fixation mechanism is similar to a cation exchange reaction, and it takes place for example, with Cs⁺ ions.
2) Reference is now made to FIG. 2 showing chemical bonding between the BOSA particles, as a Lewis base, and trace metal cations, as a Lewis acid. This is a coordinative bonding of the non-bonding electrons of the oxygen atoms of aluminates and silicates, to the trace metal cations in the solution, yielding coordination complexes, which are attached to the BOSA particles surface. This is the mechanism by which, for example, Ce³⁺, Ce⁴⁺ ions, are fixated on the surface of the BOSA particles.
3) Reference is now made to FIG. 3 showing electrostatic interactions of fine precipitates of insoluble metal salts, such as SrCO₃, via the BOSA particles at pH higher than 10.5 (usually, in an alkaline solution, the metal cations are precipitating in a form of compounds of metal oxides or hydroxides). In this case, the BOSA particles very effectively fixate the insoluble metal salt. The zeta potential of the BOSA particles at basic pH values is negative and that of the precipitate is positive which leads to a strong electrostatic interaction. As a result, the fine solid small particles can adsorb to the negative surface of the BOSA particles.

All three fixation mechanisms presented above are the result of the interaction of the fixated species with aluminate and silicate groups present at the BOSA particles surface.

The obtained wet scrubbed calcium precipitate is added to concrete mixes as a partial substitute to natural sand, aggregates and cement, for production of industrial concrete for civil engineering projects. It contains almost no calcium oxide which can be damaging to concrete. The inventors unexpectedly found that the concrete obtained in the process of the embodiment, has improved mechanical properties compared to the regular concrete used in industrial applications. Moreover, no leaching of pollutants, such as the trace elements, from the concrete was observed. This can be explained by large fixating capacity of the BOSA particles as mentioned above. As a result of the process of the present invention, scrubbing the acidic waste and storing it in large ponds become redundant.

The final scrubbed composite fixated material is in a form of large aggregates having the size of about 10 to 4000 μm. It passes all the leaching tests used in the environmental regulations and leaves no toxic hazardous residue, making it environmentally safe. Therefore, as noted above, the obtained scrubbed composite fixated material can be utilised as a partial substitute to cement, aggregates and natural sand for concrete mixture production, having improved technical properties with reduced cost, compared to a regular concrete.

Leaching tests of the resulted concrete produced from the composite fixated material of the present invention have also clearly shown that this concrete can be defined as a non-hazardous material, which means that it can be used for infrastructure purposes. Thus, the method of the present invention introduces a much more efficient, faster and cheaper way to treat the acidic wastes and produce a ‘green’ (non-polluting) composite fixated material that can be used for civil engineering projects with no need to store the treated hazardous wastes. Moreover, it has been surprisingly found that the utilisation of the composite fixated material of the present invention as a partial substitute to cement in concrete reduces the leaching of the hazardous compounds one order of magnitude compared to the neutralised product, whereas the mechanical strength of the concrete becomes significantly improved.

Experiments with the FOSA and BOSA were performed with the acidic waste collected at Rotem Amfert (Israel). The experiments testing the ability of the BOSA and FOSA to neutralise the acid waste and fixate the trace elements contained inside these wastes have shown that both FOSA and BOSA are excellent neutralisation reagents (scrubbers) and at the same time also efficient absorbers to the trace elements from the waste. Also, the scrubbed product was found to be an excellent partial substitute to sand and cement in concrete and concrete products for industrial applications. It has excellent mechanical properties and stands in all leaching tests (according to the European directive 14257-2 and the American improved leaching test 1311). The concrete based on the composite fixated material of the present invention can be successfully used in various infrastructure construction projects.

It has been surprisingly found that the concrete based on the composite fixated material of the present invention possesses enhanced properties compared to the regular concrete or concrete based on the BOSA prior to its treatment with acidic waste. Moreover, the concrete prepared from the pre-treated BOSA is unexpectedly found to be superior over the concrete prepared from the FOSA or coal fly ash. For example, the prepared hardened concrete composition of the invention containing about 50-500 kg of the BOSA particles per 1 m³ of the composition exhibits after 24 hours an increase in a compression strength of about 100-120%, while after 28 days the compression strength increases for about 70-90%. This is because the BOSA particles forming aggregates of the composite fixated material is significantly larger (about 10-4000 μm) and thus having a significantly smaller surface area compared to the FOSA particles or particles of the coal fly ash (the flying ash particles have the size less than 10 μm). In addition, there is no need to dry the obtained BOSA-based composite fixated material, whereas the similar material based on the FOSA always requires drying prior to its use in concrete mixes.

Moreover, the fact that the BOSA after its treatment with acidic waste creates a new composite fixated material demonstrating unusual and enhanced physical properties in the cement compositions is totally unpredictable and surprising. Yet further, since the step of treating the BOSA with acidic waste in the method of the present invention is actually the step when the BOSA is neutralising the acidic wastes, this may be considered a simple and ecologic solution to the problems of removal acidic wastes from the surroundings. It should be noted that while the FOSA is used in similar applications, the BOSA has never had such uses. It has always been buried in soil surrounding chemical plants. Therefore, the method of the present invention utilising the aggregates of BOSA with the neutralised waste in manufacturing the ‘green’ composite fixated material solves serious environmental problems.

To sum up, the present inventors have unexpectedly discovered a number of significant differences indicating the advantageous use of the BOSA over the FOSA in neutralising acidic waste comprising trace elements and further preparing the concrete compositions based on this obtained fixated material. These advantages are:
1) The amount of FOSA used for the preparation of concrete mixes is less than 50 kg per one cubic meter, while the composite fixated material based on BOSA can be successfully used in concrete in much larger amount, i.e. about 50-500 kg per one cubic meter.
2) After neutralising acidic waste with BOSA, the obtained BOSA aggregates can be easily used in concrete compositions as a cement substituent, whereas from the industrial point of view, FOSA cannot be used at all in the method of the present invention. This is simply because in case of using FOSA in the method of the present invention, very solid aggregates are obtained that prevent accurate weighing of the material and its application in a concrete factory.
3) The BOSA-based composite fixated material of the present invention can replace all concrete components: cement, natural sand, coarse aggregates and fine aggregates. FOSA can replace only the fractions in concrete mixtures.
4) There is no need to dry the obtained BOSA-based composite fixated material, whereas the similar material based on the FOSA always requires drying prior to its use in concrete mixes. This leads to saving huge amounts of water required to prepare the cement mixes, when using the instant BOSA-based composite fixated material containing significant amounts of water.

While certain features of the present application have been illustrated and described herein, many modifications, substitutions, changes, and equivalents will be apparent to those of ordinary skill in the art. It is, therefore, to be understood that the appended claims are intended to cover all such modifications and changes as fall within the true spirit of the present application.

1. A method for manufacturing a composite fixated material comprising:
(a) Providing bottom oil shale ash (BOSA), which is obtained after burning oil shale, wherein said BOSA comprises pozzolanic particles having size of about 10 to 4000 μm and being capable of adsorbing trace elements at their surface;
(b) Providing acidic waste comprising said trace elements; and
(c) Adding the BOSA provided in Step (a) to the acidic waste provided in Step (b) in amount of about 0.1-0.4 weight parts of said BOSA per one weight part of said waste, and mixing said waste with said BOSA, thereby obtaining a neutralised (scrubbed) precipitate with the fixated trace elements, wherein said neutralised (scrubbed) precipitate with the fixated trace elements constitutes said composite fixated material.

2. The method of claim 1, wherein said obtained composite fixated material is a cement-like powder.

3. The method of claim 1, wherein said obtained composite fixated material is a cement-like blendable paste.

4. The method of any one of claims 1 to 3, further comprising the step of transferring said obtained composite fixated material to a site of landfill and allowing it to harden, thereby obtaining a hardened concrete composition comprising the stabilised acidic waste fixated on the BOSA particles.

5. The method of any one of claims 1 to 3, further comprising the step of hardening said concrete composition.

6. The method of claim 4 or claim 5, wherein said hardened concrete composition contains about 50-500 kg of the BOSA particles per one cubic meter of the composition and exhibits after 24 hours an increase in a compression strength of about 100-120%, and after 28 days—an increase in a compression strength of about 70-90%.

7. The method of claim 1, wherein said acidic waste is in a form of sludge or filtration cake.

8. The method of claim 1, wherein said acidic waste is received from sewage sludge, sludge from municipal sanitary wastewater treatment centres, waste and wastewater treatment plants, sludge of lake or river sediments, petroleum refinery sludge, effluent sludge from pharmaceutical production, pulp and paper industry wastes, printing wastes, acrylic latex wastes, sludge from metal surface processing, leather industry wastes, and chemical industry wastes.

9. The method of claim 1, wherein said acidic waste further comprises inorganic or organic compounds.

10. The method of claim 9, wherein said inorganic or organic compounds are organophosphates, halogenated organic compounds, organometallic compounds, herbicides and pesticides.

11. The method of claim 1, wherein said trace elements are radioactive or hazardous metals.

12. The method of claim 11, wherein said radioactive or hazardous metals are U, Pb, Nb, Sr, Th, Cs, Ce, As, Cd, Hg, Cr or Ga.
